(19) United States
(12) Patent Application Publication
(10) Pub. No.: US 2018/0314409 A1
(43) Pub. Date: Nov. 1, 2018

(54) METHOD AND SYSTEM FOR CREATING AND USING EMOJIS AND OTHER GRAPHIC CONTENT IN INSTANT MESSAGING SYSTEMS

(71) Applicant: Magnificus Software Inc., Vancouver (CA)

(72) Inventors: Sahand Adilipour, Vancouver (CA); Seyed Parsa Mousavi Ghanavati, Port Coquitlam (CA)

(21) Appl. No.: 15/766,364

(22) PCT Filed: Oct. 11, 2016
(86) PCT No.: PCT/CA2016/000255

§ 371 Date: Apr. 5, 2018

Related U.S. Application Data
(60) Provisional application No. 62/239,120, filed on Oct. 8, 2015.

(51) Int. Cl. G06F 3/0484; G06F 3/0481; H04L 12/58; G06F 17/30

(52) U.S. Cl. CPC G06F 3/04845; G06F 3/04817; H04L 51/04; G06F 3/04886; G06F 17/3028; G06F 3/04842; G06F 17/30274

(57) ABSTRACT

A computer-implemented method and system performed on a mobile electronic device, wherein the system facilitates the creation of customised emojis, stickers, memes and other such graphic content by users, and facilitates the use thereof in instant messaging applications via a virtual keyboard library.

### FIELD OF THE INVENTION

The present invention relates to the field of instant messaging, and more particularly to emojis, stickers, memes and such other graphic content, in mobile instant messaging applications.

### BACKGROUND OF THE INVENTION

The widespread adoption of computers, smartphones and mobile devices by consumers has, among other things, resulted in a rapid growth in electronic communications. Increasingly, such electronic communications are being carried out, at least in part, via smartphones and other mobile devices. A variety of electronic messaging applications are well-known and widely used, including those that are based upon email, instant messaging (IM), and short message service (SMS) text. Although such messaging applications are primarily text-based, the use of emoticons, emojis, other symbols and graphic content within such electronic message applications (either separate from or in conjunction with text) is becoming increasingly popular. The use of emojis in instant messaging conversations, for example, is especially popular in Asian countries like Japan, and is gaining usage in the rest of the world.

The use of graphic content such as emoticons, emojis, stickers and memes can facilitate conversations on such electronic messaging applications, and may enhance the users' enjoyment thereof. Such graphic content can provide/add context for text-based conversations. They can provide emphasis and help to indicate a user's emotions (e.g. if the user is angry or being sarcastic). They can efficiently and accurately indicate a user's frame of mind or emotions, without having to resort to text. This is particularly useful given the nature of instant messaging and SMS conversations, which tend to be short and fast-response; additional graphic content can provide further details and clarification, thus avoiding misunderstandings. Furthermore, such graphic content can help to add humour/colour to a conversation.

Emojis are generally considered to be pictorial representations or symbols that are principally designed for use during electronic text-based (ASCII characters) messages and discussions. As mentioned above, they can be used to enhance such text-based conversations. Emojis generally tend to be relatively small in size. Digital stickers (generally referred to herein as “stickers”) and memes on the other hand are generally intended to be displayed bigger, and can work as standalone statements or messages in and of themselves. Although the distinction between emojis and stickers is not well-defined, stickers generally tend to be displayed larger than emojis. As used herein, a sticker generally functions as a standalone comment or message in and of itself, and is thus intended to be presented alone; an emoji (or more than one emoji) on the other hand can be incorporated with the text of a messages. An Internet meme is an activity, concept, catchphrase or piece of media which spreads, often as mimicry, from person to person via the Internet; it can act as a unit for carrying and spreading cultural ideas. As referred to herein, a meme generally describes graphic content, or graphic content combined with text. Like a sticker, a meme is generally intended to be displayed alone, and can function as a comment/statement/message in and of itself.

A number of instant messaging apps are known which allow users to use graphic content such as emojis, stickers and memes in their messages. In some cases, certain instant messaging apps may provide users with a limited number of “standard” emojis to use; the nature and extent of these standard emojis are generally determined by the mobile network carriers, or in some cases, by the mobile device (handset) manufacturer or by the mobile device's applicable operating system. However, these messaging apps do not generally enable users to readily create or customize their own emojis/stickers/memes. This has spawned several standalone apps which allow users to create an emoji for later use within such messaging apps. However, this process can be quite cumbersome and confusing for a user (requiring a lot of handling and a large number of “clicks”), because these standalone apps are not integrated within a messaging app. Furthermore, the messaging apps are not optimized to interface with such emoji creation apps.

Accordingly, there is an advantage in providing a method and system where instant messaging users can create and save their own emojis/stickers/memes “on the fly” within an instant messaging application and during an instant messaging discussion, and have such emoji/sticker/meme readily available for immediate or future use during such instant messaging discussions. Further, in the disclosed instant messaging system, the emojis/stickers/memes may readily be used “in-line”, i.e. integrated with a text of a message.

### SUMMARY OF THE INVENTION

Disclosed herein is a computer-implemented method and system, wherein emojis and such other graphic content may be created and used “on-the-fly” in an instant messaging application from an extended virtual keyboard of a mobile device. The method provides for the creation of emojis, stickers and memes. The present invention enables a user to create emojis, stickers and memes as a user-workflow and have such emojis, stickers and memes available in a virtual keyboard library for use when composing instant messaging text messages. Using the present system, emojis and other graphic content (including user-created, customized such content) can be used in-line with (i.e. incorporated into) text-based content in instant messages. Further, using the present system, multiple emojis can be concurrently added in-line to a message. The present invention is also directed to the described system incorporated within and integrated with an instant messaging application.

In accordance with an aspect of the present invention, disclosed herein is a computer-implemented method for facilitating instant messaging communications from a first user to a second user via user-customised graphical representations (emojis, stickers and memes), comprising: the first user selecting via a mobile device of said first user, a selected image stored on the mobile device of the first user; the first user creating the user-customised graphical representation based upon the selected image; receiving at an emoji database the user-customised graphical representation from the mobile device of the first user; assigning an identifier to such user-customised graphical representation; storing the user-customised graphical representation on the emoji database; the first user sending a sent message to the second user, wherein said sent message is an instant message communication, and said sent message includes the user-customised graphical representation; determining the identifier for the user-customised graphical representation; delivering a delivered message to the second user via a mobile device of the second user, wherein the delivered message comprises the sent message where the user-customised graphical representation is substituted with the identifier; retrieving at the mobile device of the second user, the user-customised graphical representation corresponding to the identifier from the emoji database; and displaying a displayed message via the mobile device of the second user, wherein the displayed message comprises the delivered message, where the identifier is substituted with the user-customised graphical representation, and wherein the displayed message is identical to the sent message. The first user can be provided with image editing tools for editing the selected image in order to create the user-customised graphical representation.

In accordance with another aspect of the present invention, the graphic content that is created by a user may readily be sent to and shared with other users that are on the same messaging platform, and the extent and instances of use of such graphic content can be tracked by the system.

### BRIEF DESCRIPTION OF THE DRAWINGS

Embodiments of the present invention are described below with reference to the accompanying drawings in which:

FIG. 1 is an exemplary view of the screen of a mobile device running an embodiment of the present invention, where the preliminary emoji/sticker/meme creation screen is initiated by clicking on/touching the ‘+’ symbol on the virtual keyboard.

FIG. 2 is an exemplary view of the screen of a mobile device running an embodiment of the present invention, where the preliminary emoji/sticker/meme creation screen is shown.

FIG. 3 is an exemplary view of the screen of a mobile device running an embodiment of the present invention, where the meme composer has been selected by the user.

FIG. 4 is an exemplary view of the screen of a mobile device running an embodiment of the present invention, where the emoji/sticker/meme preview screen has been selected by the user.

FIG. 5 is an exemplary view of the screen of a mobile device running an embodiment of the present invention, showing the selected emoji/sticker/meme available for use in the virtual keyboard library of the mobile device.

FIG. 6 is a diagrammatic representation illustrating how emojis, stickers and memes are each processed and handled.

FIG. 7 is a diagrammatic representation illustrating the computer environment and communications network to which the embodiments of the present invention may be applied.

FIG. 8 is a diagrammatic representation illustrating how an emoji/sticker or meme is handled within an instant messaging system.

### DETAILED DESCRIPTION OF THE INVENTION

The embodiments described herein are not, and are not intended to be, limiting in any sense. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present invention is generally illustrated herein in the form of an app, which is run on a mobile device. As used herein, mobile device can mean a smartphone, tablet, laptop computer or such other internet or communication network-enabled electronic device. An app of the sort described may be one that is developed for and run on one of a number of applicable operating systems; for example, in the case of smartphones, the app may be developed for use with an Android™-based, an iOS™-based, a Windows Phone/Mobile-based or a BlackBerry OS-based operating system, or such other operating system for mobile devices. For simplicity of reference, the action of a user in selecting icons, options or parts of the screen of the mobile devise is generally described as “clicking on” or “clicks”, although it should be understood that this can include keyboard touches, “swipes”, other user gestures or voice commands which generally operate to provide user input to the mobile device.

The present invention may also be discussed in the general context of computer code or machine-usable instructions, including computer-executable instructions such as program modules, being executed by a computer or other machine, such as a personal data assistant or other handheld mobile device. Generally, program modules including routines, programs, objects, components, data structures, etc., refer to code that perform particular tasks or implement particular abstract data types. The invention may be practiced in a variety of system configurations, including hand-held mobile devices, consumer electronics, general-purpose computers, etc.

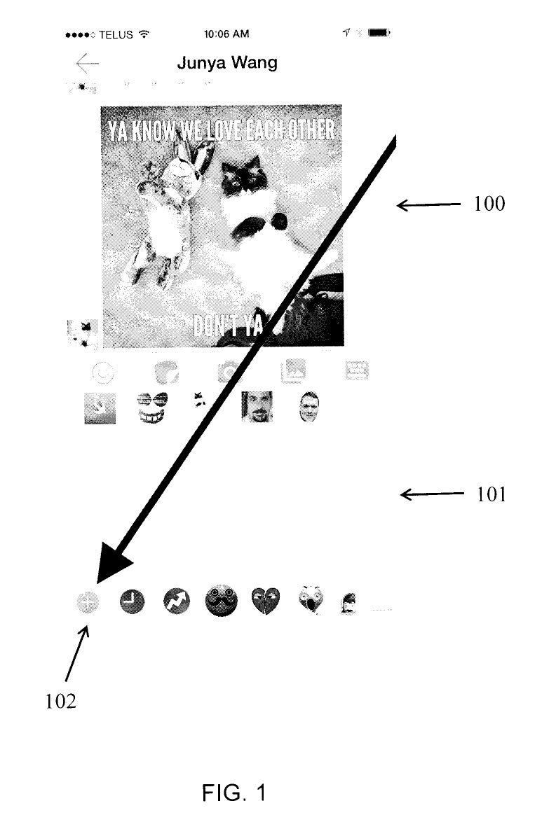

FIG. 1 is an exemplary view of the screen of a mobile device running an embodiment of the present invention. The mobile device typically includes a bus that directly or indirectly couples the following devices: memory, one or more processors, one or more presentation components, input/output (I/O) ports, input/output components, and a power supply. The bus may be one or more busses (such as an address bus, data bus, or combination thereof).

The mobile device typically includes a variety of computer-readable media. Computer-readable media can be any available media that can be accessed by the mobile device and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology.

The memory may include computer-storage media in the form of volatile and/or nonvolatile memory. The memory may be removable, non-removable, or a combination thereof. Exemplary hardware devices include solid-state memory, hard drives, optical-disc drives, etc. The mobile device may include one or more processors that read data from various entities such as a memory or I/O components. In addition, presentation component(s), such as a display device or screen, present data indications to a user.

I/O ports allow the mobile device to be logically coupled to other devices including I/O components, some of which may be built in.

In FIG. 1, the present user engages in an instant messaging conversation 100 with another user. Both users are running an application in accordance with the present invention on their respective mobile devices. When the present user wishes to compose an instant message, he “clicks” the “compose” window within the instant messaging app. This brings up an extended virtual keyboard within the instant messaging app; the virtual keyboard may be provided with various functions, including for example a standard alphanumeric keyboard, file attachment functionality, access to a library of emoticons, etc. The present user, wishing to create a custom emoji/sticker/meme for in his conversation with the other user, clicks, for example, on the “+” symbol 102 on the virtual keyboard 101, near the bottom of the screen in order to initiate the preliminary emoji/sticker/meme creation interface screen.

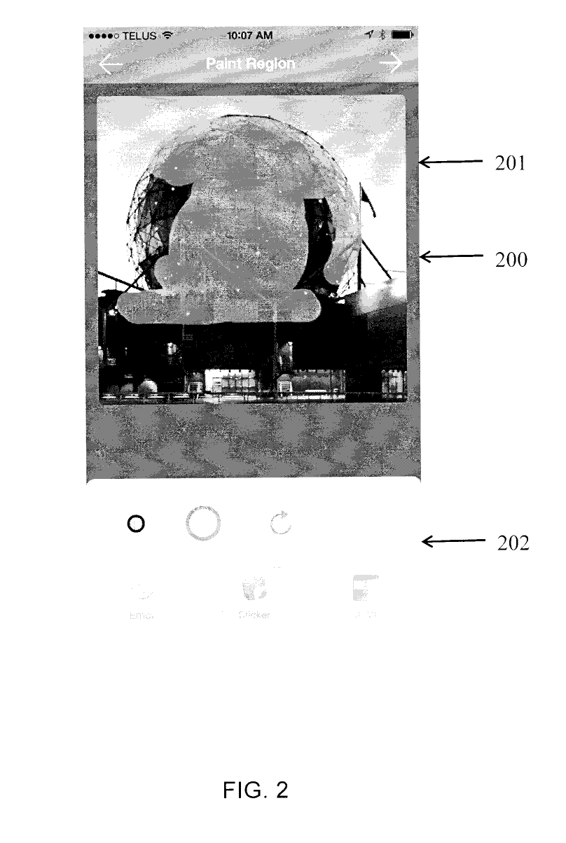

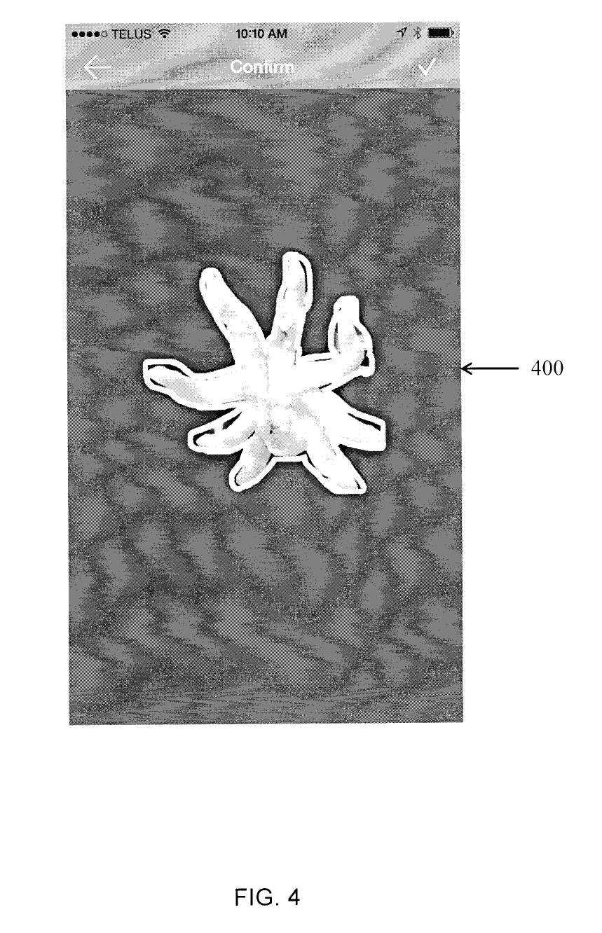

FIG. 2 shows a view of the preliminary emoji/sticker/meme creation screen 200. The user is prompted to select an appropriate existing image from the gallery of the mobile device or to take a new photo using the mobile device camera. An additional platform specific step is provided to allow the user to accept the image as-is or to edit the image (e.g. to crop, rotate, zoom-in, zoom-out, etc.) as necessary. In the present illustrated case, the user has selected a particular image 201. The creation interface screen is provided with a toolbar 202, containing a number of buttons/tabs representing various action items. The user can identify whether he wishes to use the selected image 201 to create an emoji, sticker or meme, by clicking on the applicable tab bar the bottom of the screen. Depending on whether an emoji, sticker or meme is selected by the user, the selected image 201 may be resized accordingly; in a preferred embodiment, all emojis are resized in accordance with a pre-determined emoji size, all stickers are resized in accordance with a predetermined sticker size (typically larger than emoji size), and all memes are resized in accordance with a predetermined meme size (also typically larger than emoji size). Further, depending on whether the user indicated he/she wanted to create an emoji, sticker or meme, there will be a number of other buttons that will be made available to the user in the toolbar 202. For example, if the user elects to create an emoji or a sticker, two differently-sized virtual brushes will be made available to the user. The user can crop the image, by using the virtual brush(es) to touch on the applicable area(s) of the image on the screen, to stroke or shade-in an area of interest (an active area) of the image. For example, the user may wish to only select one or more particular portions of the image, or perhaps wish to select the foreground from the image and remove the background. The active area will become the image that is the subject for the user-created emoji/sticker. Another button can allow the user to “undo” recent actions. This is illustrated in FIG. 4, where the user has used a photo or image containing an octopus, and has stroked/shaded-in an area corresponding to the octopus, in order to use the resulting graphic of the octopus as the subject of an emoji.

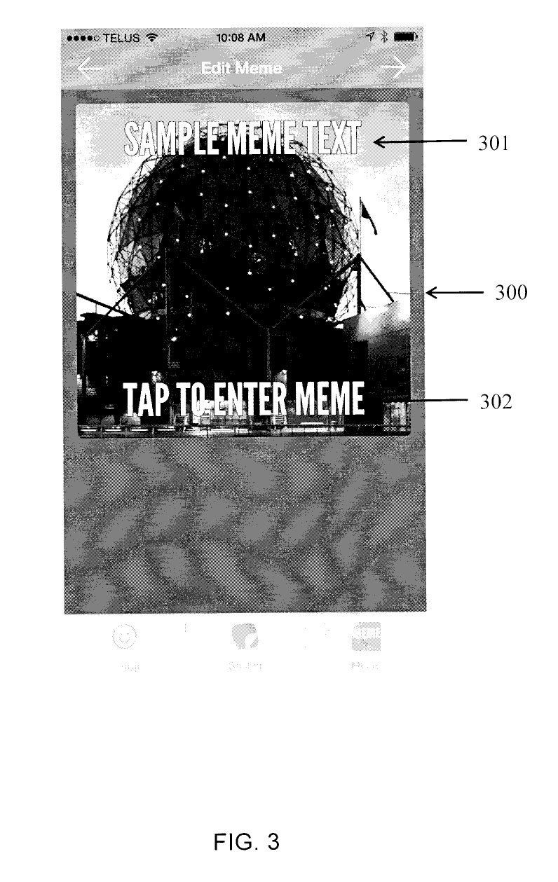

Because of their nature, memes are treated slightly differently from emojis and stickers. Where the user elects to create a meme, the user can be prompted with placeholder text. The placeholder text may be presented at the top and/or bottom of the image. For example, this may include accompanying text for the meme 301 or a title/name 302 therefor. The user can input/type in any applicable text that he wishes to include in the meme. FIG. 3 illustrates the screen view for the meme composer.

In each of the cases, once the user clicks that he is satisfied with his composition, he is shown a preview of the emoji/sticker or meme. This is illustrated in FIG. 4, where a particular customized emoji 400 has been created by the user.

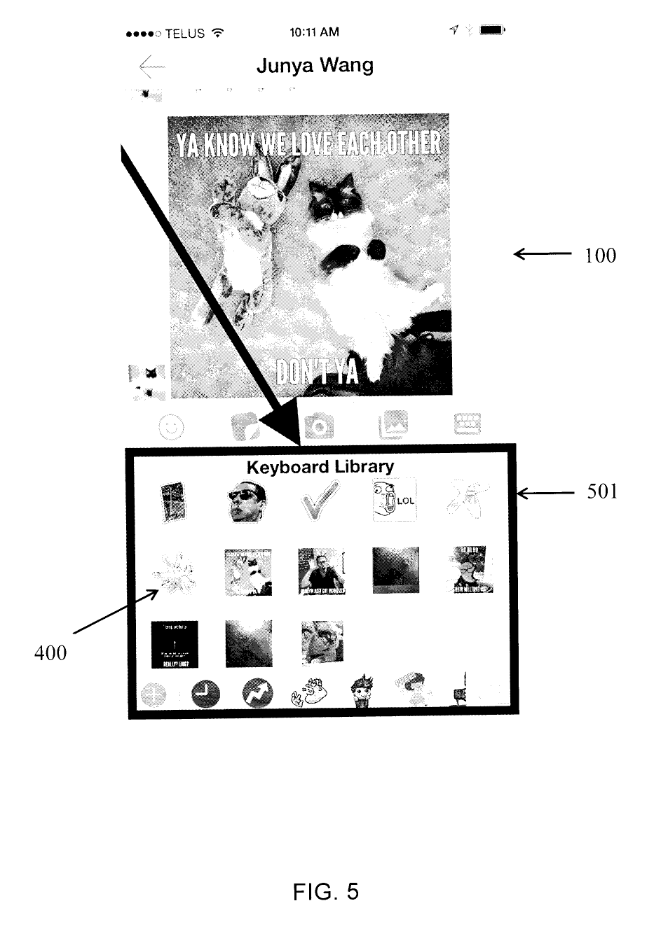

Referring to FIG. 5, upon clicking “Save”, the user is returned to the original message composition screen 100. This time, however, the emoji, sticker or meme 400 that has just been created by the user, is shown in the virtual keyboard library 501 and is available for the user to select/use in composing his next instant message. The virtual keyboard library can comprise one or more tabs for the purpose of categorization. For example, all user-created emojis/stickers/memes may be presented in a single general tab, and/or emojis, stickers and memes may each be presented in their own separate tab or tabs.

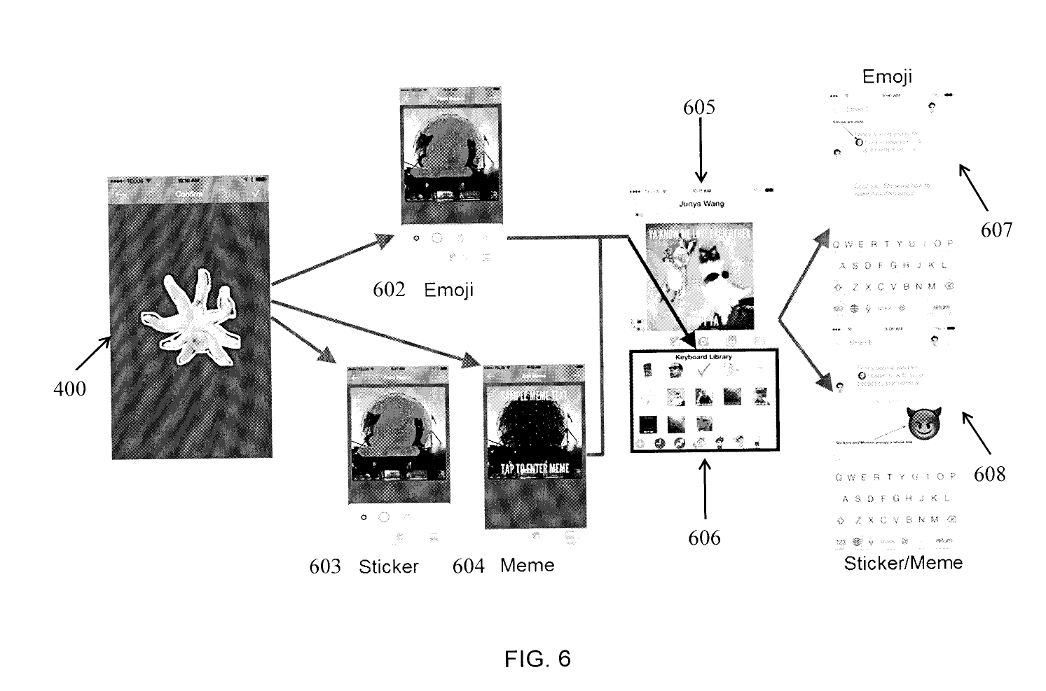

FIG. 6 is a diagrammatic representation summarizing how the types of different graphic content (emojis, stickers and memes) are each processed and handled. A cropped image created by the user 400 may be designated as an emoji 602, sticker 603 or meme 604. Once the content has been “saved”, the content appears in the user's virtual keyboard 606 within the user's instant messaging chat window 605, and is available for use by that user. In the case where the graphic content was saved as an emoji, the emoji can show up in-line with (incorporated within) the text of the instant messaging chat screen 607; in the case where the graphic content was saved as a sticker or meme, this appears as a standalone graphic 608.

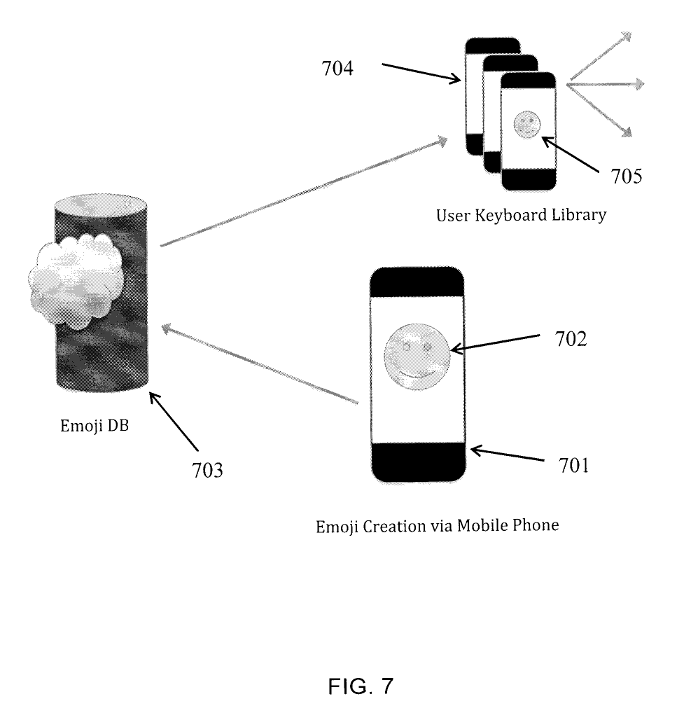

FIG. 7 is a diagrammatic representation illustrating the computer environment and communications network to which the embodiments of the present invention may be applied. When the above-referenced user (sometimes referred to herein as the “creator user”), having created an emoji/sticker/meme 702, clicks “Save”, the mobile client uploads the emoji/sticker/meme image 702 to a cloud-based emoji database 703 (such as, for example, to Amazon™ S3 storage). A unique web link (web URL) indicating the web location where the image 702 is stored is generated. The unique ID for the image 702 and the web link for the image 702 are stored on a cloud database (not specifically shown). The cloud database provides a web link to the user-created image 702, so it can be loaded as any web image. Any pertinent or useful information regarding each user-created image 702 may also be stored in the cloud database too, such as a unique identifier (_id), the identity of the creator user (author_id), web link to uploaded image, creation date, etc. Optionally, the image 702 itself may also be saved to the cloud database. In the same database, as mentioned above, every saved emoji/meme/sticker 702 is assigned a unique identifier. As each emoji/sticker/meme 702 is inserted into the cloud database, the respective unique identifiers for the emoji/sticker/meme are additionally populated to the set of subscribed graphics in the user's database. The new emoji/sticker/meme graphic content 702 is saved to the creator user's (i.e. the user who created the emoji/sticker/meme) graphics subscriptions. Within a short span of time, the graphic content is populated into the user's cloud library of emojis/sticker/memes and the virtual keyboard library 704 on the mobile client “syncs” the graphic content from the cloud-based emoji database 703. This makes the content available for use in the creator user's keyboard library 704.

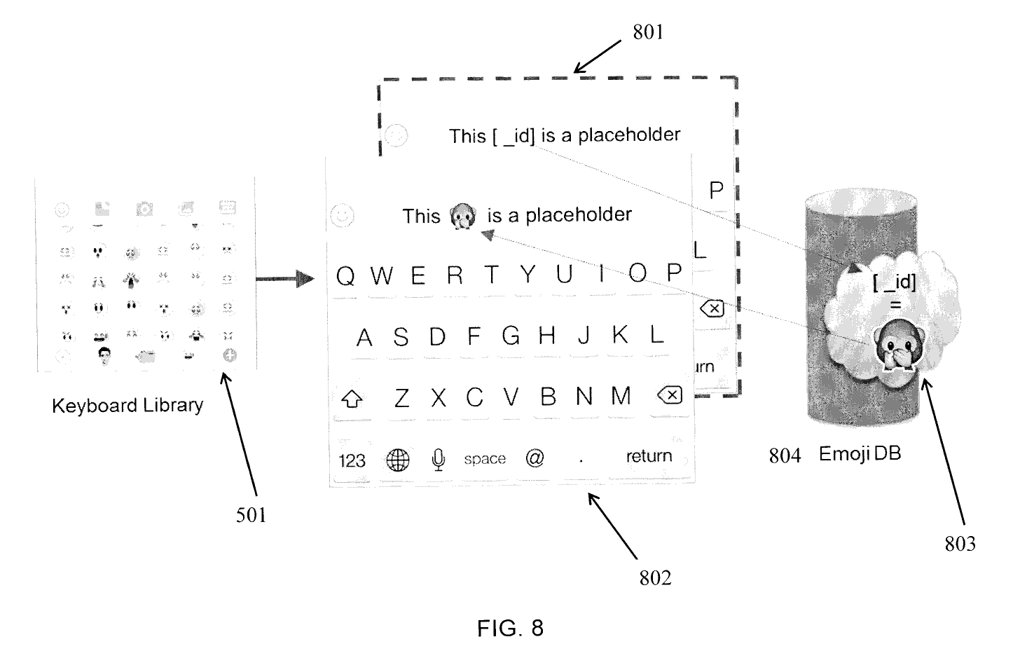

When the creator user sends instant messages containing emojis or other graphic content selected from their virtual keyboard library 501, in effect he is creating a placeholder for the graphic content, in the message payload. This placeholder references the unique identifier for the emoji or graphic content. When the message payload is delivered to the recipient, as explained below, the placeholder reference is fetched from the cloud-based emoji database 703 and the graphic content 702 is downloaded and rendered with minimal lag. This allows the recipient to view the creator user's intended message, complete with the graphic content 702; the message may be a standalone sticker, meme or emojis, or may be a text message with in-line emojis (i.e. text which incorporates one or more emojis therein), as the case may be. The foregoing is illustrated in FIG. 8, where the graphic content that is available for the user to use is presented in the virtual keyboard library 501. When such content is used in an instant messaging message, a placeholder specifying the location of the graphic content within the text is indicated along with the applicable unique identifier (_id) of such graphic content. When a recipient receives the instant message, the complete message 802 is reconstructed by fetching the relevant graphic content 803 from the emoji database 804, and incorporating it into the location of the applicable placeholder.

When the present user sends messages with the emoji graphic content to other users on the system (i.e. on the same instant messaging platform), the graphic content is automatically added to the recipient's cloud library of emoji/stickers/memes. Using the same mechanism as described above, the unique identifier of the emoji/sticker/meme is added to the recipient's list of graphic subscriptions. Thus, the recipient will also be able to access that emoji/sticker/meme in her virtual keyboard library and the recipient will be able to select and use it in her future instant messaging conversations. As users on the system share emojis, stickers and memes with each other, the shared graphic content automatically appears on those users' virtual keyboard libraries. This facilitates the viral adoption of the graphic content.

As described above, the system is configured such that for each custom emoji, sticker or meme from a user's library, each such custom graphic is provided with a unique ID or identifier, and the system keeps count of each time that such emoji/sticker/meme is sent from one user to another. This enables the tracking of each emoji/sticker/meme. Accordingly, lists can be compiled of specific graphic content according to certain predetermined criteria, such as popularity, etc. By way of example, a “trending emoji” list can sort and pick emojis within a certain pre-set time period (say 24 hours). In this fashion, a set of top emojis/memes (e.g. a top 20 most commonly used) can automatically be added to every user's library, under a “Trending” tab. Again, this feature encourages and facilitates the viral adoption of popular emojis, while keeping it current and meaningful.

We claim:

1. A computer-implemented method for facilitating instant messaging communications from a first user to a second user using user-customised graphical representations, comprising:
the first user selecting via a mobile device of said first user, a selected image stored on the mobile device of the first user;
the first user creating the user-customised graphical representation based upon the selected image;
receiving at an emoji database the user-customised graphical representation from the mobile device of the first user;
assigning an identifier to such user-customised graphical representation;
storing the user-customised graphical representation on the emoji database;
the first user sending a sent message to the second user, wherein said sent message is an instant message communication, and said sent message includes the user-customised graphical representation;
determining the identifier for the user-customised graphical representation;
delivering a delivered message to the second user via a mobile device of the second user, wherein the delivered message comprises the sent message where the user-customised graphical representation is substituted with the identifier;
retrieving at the mobile device of the second user, the user-customised graphical representation corresponding to the identifier from the emoji database; and
displaying a displayed message via the mobile device of the second user, wherein the displayed message comprises the delivered message, where the identifier is substituted with the user-customised graphical representation, and wherein the displayed message is identical to the sent message.

2. The computer-implemented method of claim 1, wherein in the step of storing the user-customised graphical representation on the emoji database, the user-customised graphical representation is stored at a web location, and a web link corresponding to the web location and the identifier are stored on a cloud database; and
wherein in the step of retrieving the user-customised graphical representation, the web location is determined in accordance with the identifier from the cloud database, and the user-customised graphical representation is retrieved from the emoji database according to the web location.

3. The computer-implemented method of claim 1, wherein the graphical representation is selected from the group consisting of an emoji; a digital sticker and a meme.

4. The computer-implemented method of claim 1, wherein the user-customised graphical representation is created by the first user digitally editing the selected image via the mobile device of the first user.

5. The computer-implemented method of claim 1, wherein the user-customised graphical representation is stored as a web image and wherein a web link providing the location of the user-customised graphical representation is stored on a cloud database.

6. The computer-implemented method of claim 1, wherein the emoji database is a cloud-based database.

7. The computer-implemented method of claim 1, wherein the user-customised graphical representation is an emoji, and wherein the sent message includes said user-customised graphical representation and text.

8. The computer-implemented method of claim 7, wherein the user-customised graphical representation and text are presented in-line.

9. The computer-implemented method of claim 1, wherein each user-customised graphical representation is provided with a corresponding emoji counter, said emoji counter representing the number of instances that the user-customised graphical representation has been sent between users.

10. A computer readable memory having recorded thereon instructions executable by a computer, said instructions comprising:
a first user selecting via a mobile device of said first user, a selected image stored on the mobile device of the first user;
the first user creating a user-customised graphical representation based upon the selected image;
receiving at an emoji database the user-customised graphical representation from the mobile device of the first user;
assigning an identifier to such user-customised graphical representation;
storing the user-customised graphical representation on the emoji database;
the first user sending a sent message to a second user, wherein said sent message is an instant message communication, and said sent message includes the user-customised graphical representation;
determining the identifier for the user-customised graphical representation;
delivering a delivered message to the second user via a mobile device of the second user, wherein the delivered message comprises the sent message where the user-customised graphical representation is substituted with the identifier;
retrieving at the mobile device of the second user, the user-customised graphical representation corresponding to the identifier from the emoji database; and
displaying a displayed message via the mobile device of the second user, wherein the displayed message comprises the delivered message, where the identifier is substituted with the user-customised graphical representation, and wherein the displayed message is identical to the sent message.

11. A computer program product comprising a computer readable memory storing computer executable instructions thereon that when executed by a computer perform the method steps of claim 1.
